(19) United States
(12) Patent Application Publication
(10) Pub. No.: US 2012/0147699 A1
(43) Pub. Date: Jun. 14, 2012

(54) DISTANCE- AND FREQUENCY-SEPARATED SWEPT-FREQUENCY SEISMIC SOURCES

(75) Inventors: Joseph A. Dellinger, Houston, TX (US); Raymond Lee Abma, Houston, TX (US)

(73) Assignee: BP CORPORATION NORTH AMERICA INC., Houston, TX (US)

(21) Appl. No.: 13/315,925

(22) Filed: Dec. 9, 2011

Related U.S. Application Data
(60) Provisional application No. 61/421,707, filed on Dec. 10, 2010.

(51) Int. Cl. G01V 1/38; G01V 1/24

(52) U.S. Cl. 367/15; 367/37

(57) ABSTRACT

There is provided a method of seismic acquisition that utilizes a bank of restricted-bandwidth swept-frequency sub-band sources as a seismic source. Each seismic source will cover a restricted sub-band of frequencies, with all the sources taken together covering the full frequency range. Adjacent frequency bands may partially overlap, but non-adjacent frequency bands should not. The sources may be divided into two or more groups, with no sources covering adjacent frequency bands being placed in the same group. The sources within a group can then be separated by bandpass filtering or by conventional simultaneous source-separation techniques. The source groups may be operated simultaneously but separated in space, and the individual sources themselves may each operate independently, on a sweep schedule customized for that particular source.

### RELATED CASE

This application claims the benefit of U.S. Provisional Patent Application Ser. No. 61/421,707, filed on Dec. 10, 2010, and incorporates said provisional application by reference into this disclosure as if fully set out at this point.

### TECHNICAL FIELD

This invention relates to the general subject of seismic exploration and, in particular, to methods for acquiring seismic and other signals that are representative of the subsurface for purposes of seismic exploration.

### BACKGROUND OF THE INVENTION

A seismic survey represents an attempt to image or map the subsurface of the earth by sending sound energy down into the ground and recording the “echoes” that return from the rock layers below. The source of the down-going sound energy might come, for example, from explosions or seismic vibrators on land, or air guns in marine environments. During a seismic survey, the energy source is placed at various locations near the surface of the earth above a geologic structure of interest. Each time the source is activated, it generates a seismic signal that travels downward through the earth, is reflected, and, upon its return, is recorded at a great many locations on the surface. Multiple source/recording combinations are then combined to create a near continuous profile of the subsurface that can extend for many miles. In a two-dimensional (2-D) seismic survey, the recording locations are generally laid out along a single line, whereas in a three dimensional (3-D) survey the recording locations are distributed across the surface in a grid pattern. In simplest terms, a 2-D seismic line can be thought of as giving a cross sectional picture (vertical slice) of the earth layers as they exist directly beneath the recording locations. A 3-D survey produces a data “cube” or volume that is, at least conceptually, a 3-D picture of the subsurface that lies beneath the survey area. In reality, though, both 2-D and 3-D surveys interrogate some volume of earth lying beneath the area covered by the survey. Finally, a 4-D (or time-lapse) survey is one that is taken over the same subsurface target at two or more different times. This might be done for many reasons but often it is done to measure changes in subsurface reflectivity over time which might be caused by, for example, the progress of a water flood, or movement of a gas/oil or oil/water contact, etc. If successive images of the subsurface are compared any changes that are observed (assuming differences in the source signature, receivers, recorders, ambient noise conditions, etc., are accounted for) will be attributable to the progress of the subsurface processes that are at work.

A seismic survey is composed of a very large number of individual seismic recordings or traces. In a typical 2-D survey, there will usually be several tens of thousands of traces, whereas in a 3-D survey the number of individual traces may run into the multiple millions of traces. Chapter 1, pages 9-89, of Seismic Data Processing by Ozdogan Yilmaz, Society of Exploration Geophysicists, 1987, contains general information relating to conventional 2-D processing and that disclosure is incorporated herein by reference. General background information pertaining to 3-D data acquisition and processing may be found in Chapter 6, pages 384-427, of Yilmaz, the disclosure of which is also incorporated herein by reference.

A seismic trace is a digital recording of the acoustic energy reflecting from inhomogeneities or discontinuities in the subsurface, a partial reflection occurring each time there is a change in the elastic properties of the subsurface materials. The digital samples are usually acquired at 0.002 second (2 millisecond or “ms”) intervals, although 4 millisecond and 1 millisecond sampling intervals are also common. Each discrete sample in a conventional digital seismic trace is associated with a travel time, and in the case of reflected energy, a two-way travel time from the source to the reflector and back to the surface again, assuming, of course, that the source and receiver are both located on the surface. Many variations of the conventional source-receiver arrangement are used in practice, e.g. VSP (vertical seismic profiles) surveys, ocean bottom surveys, etc. Further, the surface location of every trace in a seismic survey is carefully tracked and is generally made a part of the trace itself (as part of the trace header information). This allows the seismic information contained within the traces to be later correlated with specific surface and subsurface locations, thereby providing a means for posting and contouring seismic data—and attributes extracted therefrom—on a map (i.e., “mapping”).

The data in a 3-D survey are amenable to viewing in a number of different ways. First, horizontal “constant time slices” may be extracted from a stacked or unstacked seismic volume by collecting all of the digital samples that occur at the same travel time. This operation results in a horizontal 2-D plane of seismic data. By animating a series of 2-D planes it is possible for the interpreter to pan through the volume, giving the impression that successive layers are being stripped away so that the information that lies underneath may be observed. Similarly, a vertical plane of seismic data may be taken at an arbitrary azimuth through the volume by collecting and displaying the seismic traces that lie along a particular line. This operation, in effect, extracts an individual 2-D seismic line from within the 3-D data volume. It should also be noted that a 3-D dataset can be thought of as being made up of a 5-D data set that has been reduced in dimensionality by stacking it into a 3-D image. The dimensions are typically time (or depth “z”), “x” (e.g., North-South), “y” (e.g., East-West), source-receiver offset in the x direction, and source-receiver offset in the y direction. While the examples here may focus on the 2-D and 3-D cases, the extension of the process to four or five dimensions is straightforward.

Seismic data that have been properly acquired and processed can provide a wealth of information to the explorationist, one of the individuals within an oil company whose job it is to locate potential drilling sites. For example, a seismic profile gives the explorationist a broad view of the subsurface structure of the rock layers and often reveals important features associated with the entrapment and storage of hydrocarbons such as faults, folds, anticlines, unconformities, and sub-surface salt domes and reefs, among many others. During the computer processing of seismic data, estimates of subsurface rock velocities are routinely generated and near-surface inhomogeneities are detected and displayed. In some cases, seismic data can be used to directly estimate rock porosity, water saturation, and hydrocarbon content. Seismic waveform attributes such as phase, peak amplitude, peak-to-trough ratio, and a host of others can often be empirically correlated with known hydrocarbon occurrences and that correlation applied to seismic data collected over new exploration targets.

An ideal marine seismic source would cover the entire frequency band of interest, and only the frequency band of interest for seismic surveying, e.g., about 1-100 Hz, or even higher (e.g., up to 300 Hz) depending on the survey objectives. Swept-frequency sources are of increasing interest as an alternative to conventional sources due to their ability to control the bandwidth of their signal sweep. However, in practice it is very difficult to build a single swept-frequency source that covers this entire range.

One solution would be to apportion the frequency range among multiple sources. One suggestion (made in a land context) requires “handing off” from one source to the next in sequence to construct a single multi-source sweep. This has two difficulties. First, for marine resonator sources achieving the necessary control to precisely synchronize the phases of two or more resonators is likely to be difficult. Second, each individual source then spends most of its time idle when it could be usefully radiating energy, which is not an efficient use of this expensive resource.

It has also been proposed (again in a land context) to operate multiple sources in substantially disjoint frequency bands simultaneously, which addresses the second problem identified above. However, in this method, the multiple sources must all have sweeps of the same length, and in the frequency ranges where the sources overlap, the phases of the sources must again be carefully controlled so that the signals are mathematically orthogonal and thus separable. However, this proposal again fails to address the first problem discussed above.

Another proposal involves operating multiple swept-frequency sources that partition the frequency band of interest, this time in a marine context. However, this approach does not provide a methodology for how to operate the sources such that they can be separated in processing while still covering the entire frequency band of interest. Thus, what is needed is a strategy both for how to operate the sources and how to record and process the resulting seismic data such that they are useful.

Finally, none of these methods attempts to take advantage of the fact that different minimum source separations are used in different frequency bands. Other methods have almost uniformly assumed the same shot spacing for all frequency bands, as would be the case in conventional airgun acquisition. Different frequency bands have differing optimal shot spacings, a fact that should be made use of in survey design if the type of sources being used makes it possible. It is not possible with airguns, but with swept-frequency sources partitioning a frequency range of interest, it potentially is.

Heretofore, in the seismic acquisition and processing arts, there has been a need for a system and method that does not utilize a full-bandwidth impulsive source such as an airgun, but instead uses controlled-frequency restricted-bandwidth source(s) that efficiently cover just the desired range of useful frequencies. Accordingly, it should now be recognized, as was recognized by the present inventor, that there exists, and has existed for some time, a very real need for a method of seismic data acquisition and processing that would address and solve the above-described problems.

Before proceeding to a description of the present invention, however, it should be noted and remembered that the description of the invention which follows, together with the accompanying drawings, should not be construed as limiting the invention to the examples (or various embodiments) shown and described. This is so because those skilled in the art to which the invention pertains will be able to devise other forms of this invention within the ambit of the appended claims.

### SUMMARY OF THE INVENTION

According to a one aspect of the instant invention, there is provided a system and method for acquiring seismic data utilizing multiple restricted-bandwidth seismic sources that, when combined, produce data that have a useful frequency content comparable to that of a broadband seismic survey.

There is provided herein a method of seismic acquisition that in one embodiment utilizes a bank of restricted-bandwidth swept-frequency sources as a seismic source. As used herein, these banks will generally be referred to hereinafter as “sub-band sources”. Each sub-band source will generally cover a relatively restricted band of frequencies, be substantially disjoint from the others, and be chosen such that all the sub-band sources taken together cover a predetermined (likely broadband) frequency range. The sub-bands and associated sub-band seismic sources will typically be selected such that those sources that generate a seismic signal in adjacent frequency bands may partially overlap, but non-adjacent frequency bands will not overlap.

The bank of sub-band sources will then be divided into two or more groups, such that no sources that are assigned to adjacent frequency sub-bands are placed in the same group. Such a group of sources will be referred to as a “sub-band source group” or just “source group”, hereinafter. The sub-band sources within each sub-band source group can be readily separated in the frequency domain by simple bandpass filtering, allowing each sub-band source to essentially be operated independently (i.e., without regard for what the other sub-band sources are doing). That may mean that the sub-band sources will be activated simultaneously, sequentially, contemporaneously (e.g., two or more of the sources in a group may overlap in time), etc. It would be most efficient for acquisition purposes for all of the sub-band sources in the same source group to be simultaneously active.

The sub-band sources within each sub-band source group will usually be separable by frequency, but sub-band sources in different sub-band source groups that cover adjacent frequency sub-bands may overlap somewhat in frequency. That being said, in some embodiments non-adjacent frequency sub-bands will be disjoint, with adjacent sub-bands being allowed some minimal amount of overlap. Other survey techniques utilize sources whose phases can be carefully controlled, so that the overlapping signals can either be made orthogonal or coincident. Instead, the instant approach distinguishes the sub-band sources by time or location or both. In one embodiment the sources will be arranged such that two sub-band sources are not located close to each other if they are making similar frequencies at the same time.

In another embodiment, the method comprises separating the overlapping sources in time by performing a separate acquisition pass for each sub-band source group. Another embodiment may be to operate them simultaneously but separated in space, using established methods for separating independent simultaneous sources that take advantage of their distinct spatial locations to separate them, and taking further advantage of the unsynchronized sweeps being performed by each source. Methods to enhance simultaneous source separation, e.g., dithered shot times, using both up sweeps and down sweeps, etc., can also be applied. See for example Abma, R., 2010, Method for separating independent simultaneous sources: patent US 20100039894 A1.

According to one embodiment, a method of seismic exploration comprises providing a plurality of seismic sources. The seismic sources will be, in some embodiments, customizable to transmit at least approximately within a specified frequency sub-band. The frequency sub-bands transmitted by the plurality of seismic sources will be chosen to cover a pre-selected frequency range. The method further comprises dividing the plurality of seismic sources into at least two source groups. The frequency sub-bands transmitted by the seismic sources within the same source group are non-adjacent to each other. In addition, the method comprises transmitting a plurality of signals from the source groups, continuously recording a plurality of reflected, refracted, or transmitted seismic signals indicative of one or more subterranean formations.

According to another embodiment, there is provided, a method of seismic exploration above a region of the subsurface of the earth containing structural or stratigraphic features conducive to the presence, migration, or accumulation of hydrocarbons, involves selecting a frequency range; selecting a plurality of sub-bands of said frequency range, said plurality of frequency sub-bands taken together substantially covering said selected frequency range; associating at least one seismic source with each of said plurality of frequency sub-bands, wherein each seismic source associated with one of said plurality of frequency sub-bands at least approximately covers said associated frequency sub-band; assigning each of said plurality of sub-bands and said at least one seismic source associated therewith to one of at least two source groups in such a way that no two adjacent sub-bands are assigned to a same source group; collecting a seismic survey by separately recording activations of said seismic sources associated with each of said each of said at least two source groups, wherein activation of said seismic sources associated with one source group does not materially overlap in time activation of said seismic sources associated with another source group; and, using at least a portion of said seismic survey to explore for hydrocarbons within said subsurface of the earth.

According to still another embodiment, there is provided a method of seismic exploration above a region of the subsurface of the earth containing structural or stratigraphic features conducive to the presence, migration, or accumulation of hydrocarbons wherein at least two frequency sub-bands are selected, wherein said at least two sub-bands substantially covers a predetermined frequency range, and wherein non-adjacent sub-bands do not overlap in frequency; wherein at least one seismic source is assigned to each of said sub-bands, wherein a seismic source assigned to a particular sub-band emits seismic sources waves that are largely confined in frequency to its assigned particular sub-band; wherein each of said at least two sub-bands and said at least one seismic source assigned thereto are assigned to one of at least two source groups in such a way that no two adjacent sub-bands are assigned to a same source group; wherein a seismic survey is collected above said region of the subsurface of the earth by alternately activating each of said source groups proximate to said region of the subsurface of the earth and recording any seismic signals returned from the subsurface of the earth; and, wherein at least a portion of said seismic survey is used to explore for hydrocarbons within said subsurface of the earth.

According to a further embodiment, there is provided a method of seismic exploration above a region of the subsurface of the earth containing structural or stratigraphic features conducive to the presence, migration, or accumulation of hydrocarbons, comprising: positioning at least two seismic source groups over said region of the earth, wherein each seismic group comprises a plurality of seismic sources, wherein at least one of said seismic source groups is assigned at least two frequency sub-bands, wherein said frequency sub-band(s) assigned to a single seismic source group do not overlap in frequency, and wherein all of said frequency sub-bands taken together substantially cover a predetermined frequency range; assigning at least one seismic source to each of said frequency sub-bands, wherein each seismic source assigned to one of said frequency sub-bands emits seismic-source waves that are confined in frequency to its assigned sub-band; assigning each of said at least two frequency sub-bands and said at least one seismic source assigned thereto to one of at least two seismic source groups in such a way that no two adjacent frequency sub-bands are assigned to any one of said seismic source groups; and activating each of said seismic source groups proximate to said region of the subsurface of the earth and recording any seismic signals returned from the subsurface of the earth; and, displaying at least a portion of said seismic survey on a computer associated display device.

Finally, and according to still a further embodiment, there is disclosed a method of seismic exploration within the subsurface of the earth, comprising the steps of: accessing a seismic data set collected by the steps of: selecting a plurality of sub-bands that substantially cover a frequency range; associating at least one seismic source with each of said plurality of frequency sub-bands, wherein each seismic source associated with one of said plurality of frequency sub-bands emits seismic energy that is largely confined to said associated frequency sub-band; assigning each of said plurality of sub-bands and said at least one seismic source associated therewith to one of at least two source groups in such a way that no two adjacent sub-bands are assigned to a same source group; and, collecting said seismic data set by recording activations of said seismic sources associated with each of said each of said at least two source groups, wherein activation of said seismic sources associated with one source group is separated either in time or in distance from activation of said seismic sources associated with a different source group; and, using at least a portion of said accessed seismic data set to explore for hydrocarbons within the subsurface of the earth.

The foregoing has outlined in broad terms the more important features of the methods disclosed herein so that the detailed description that follows may be more clearly understood, and so that the contribution of the instant inventor to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

Other aspects and advantages of the methods and systems will become apparent upon reading the following detailed description and upon reference to the drawings in which:

FIG. 1 illustrates the general environment of one aspect of the instant invention.

FIG. 2 illustrates a methodology for the initial survey design (expanding box 110 in FIG. 1).

FIG. 3A illustrates a conventional approach to collecting a seismic survey.

FIGS. 3B and 3C contain some example source frequency sweeps suitable for use with the instant invention.

FIG. 4 illustrates one acquisition geometry implementing the sweep strategy of panel 340 in FIG. 3C.

FIG. 5 illustrates an alternative to the embodiment of FIG. 2, wherein the steps enclosed by bounding box 290 have been replaced by steps 555 through 585.

### DETAILED DESCRIPTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

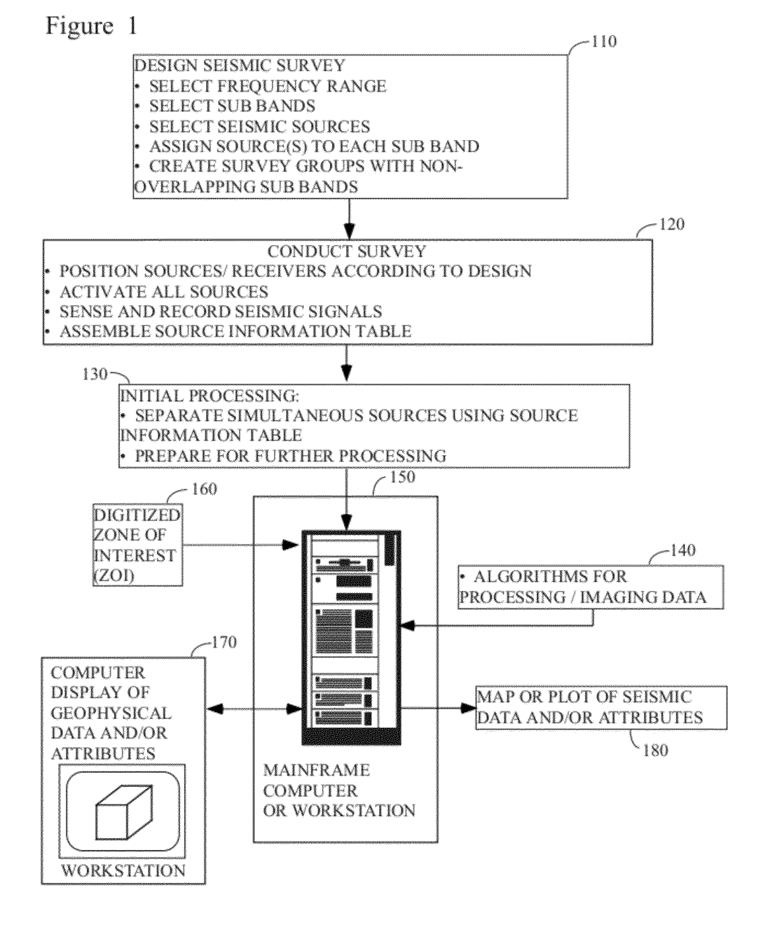

FIG. 1 illustrates the general methodology in which the instant invention would typically be used. A seismic survey is designed 110 by the explorationist to cover an area of economic interest. Field acquisition parameters (e.g., shot spacing, line spacing, fold, etc.) are typically selected in conjunction with this step, although it is common to modify the ideal design parameters slightly (or substantially) in the field to accommodate the realities of conducting the survey. The instant invention would be most useful if implemented in conjunction with the collection of a conventional or unconventional 2-D or 3-D seismic survey.

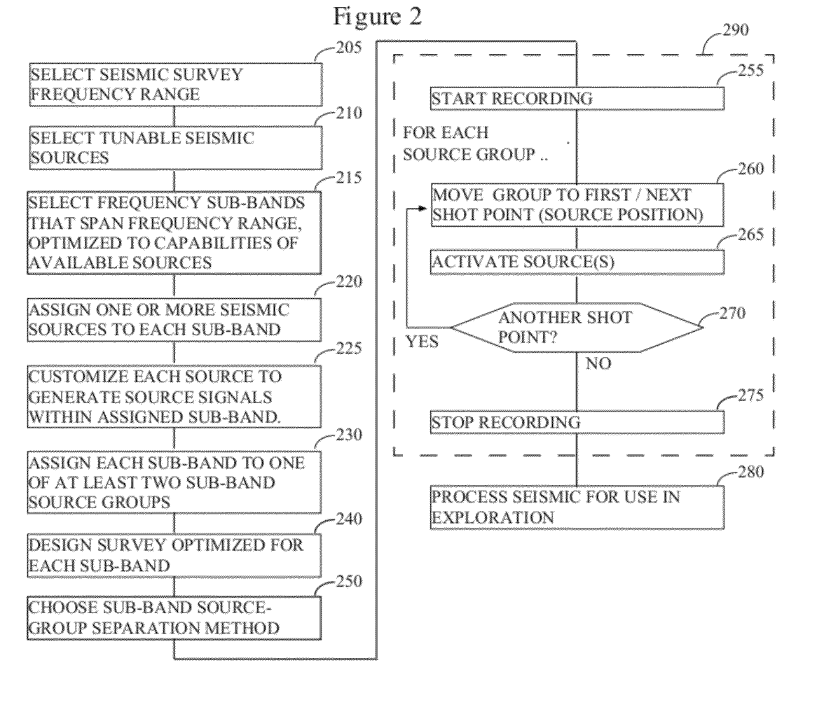

Seismic data (i.e., seismic traces) are collected in the field 120 (with one possible embodiment of how to do this expanded in boxes 255 to 275 in FIG. 2) over a subsurface target of potential economic importance and are typically sent thereafter to a processing center or computer 150 where the traces will be subjected to various algorithms to make them more suitable for use in exploration. In some cases, there may be some amount of initial data processing performed while the data are still in the field and this is becoming more common and feasible given the computing power that is available to field crews.

In the processing center the data recorded by the technique of the instant invention will typically initially be processed via algorithms 130 that render it into a form suitable for conventional imaging algorithms 140. Algorithms 130 and 140 would best be loaded onto a programmable computer 150 where it is accessible by a seismic interpreter or processor. Note that a computer 150 suitable for use with the instant invention would typically include, in addition to mainframes, servers, and workstations, super computers and, more generally, a computer or network of computers that provide for parallel and massively parallel computations, wherein the computational load is distributed between two or more processors.

As is also illustrated in FIG. 1, in one arrangement some sort of digitized zone of interest model 160 may be specified by the user and provided as input to the processing computer program. In the case of a 3-D seismic section, the zone of interest model 160 would typically include specifics as to the lateral extent and thickness (which might be variable and could be measured in time, depth, frequency, etc.) of a subsurface target. The exact means by which such zones are created, picked, digitized, stored, and later read during program execution is unimportant to the instant invention and those skilled in the art will recognize that this might be done any number of ways.

The algorithms 130 and 140 might be conveyed into the computer that is to execute them by means of, for example, a floppy disk, a magnetic disk, a magnetic tape, a magneto-optical disk, an optical disk, a CD-ROM, a DVD disk, a RAM card, flash RAM, a RAM card, a PROM chip, or loaded over a network. In a typical seismic processing environment, the processing component of the instant invention would be made part of a larger package of software modules. After processing by the instant methods, the resulting traces would then typically be sorted into gathers, stacked, and displayed either on a high-resolution color computer monitor 170 or other computer display device, or in hard-copy form as a printed seismic section or a map 180 (paper or other hard copies, computer-attached display devices, and other devices for viewing seismic data will collectively be referred to as “computer associated display devices”, hereinafter). The seismic interpreter would then use the displayed images to assist him or her in identifying subsurface features conducive to the generation, migration, or accumulation of hydrocarbons.

The general flow of this processing sequence is familiar to those skilled in the art of seismic processing and exploration. The main components of the instant invention lie in the details of steps 110, 120 and 130.

In step 110, instead of designing a single seismic survey as would be standard practice, in one embodiment of the instant invention a set of restricted-frequency seismic surveys will be designed that are intended to be performed together.

FIG. 2 shows one approach to this process. As an initial typical step, an overall desired frequency range 205 (bandwidth) for the survey will be selected, as might be done in the case of, for example, a conventional seismic survey. Next, in one embodiment a set of available swept-frequency seismic sources 210 will be chosen that will be used to perform the survey. In one embodiment, the overall frequency range will then be divided into restricted-frequency sub-bands 215, taking into account the capabilities of the available sources as this is done.

In the embodiment currently under discussion, the sources that are to be assigned to each sub-band 220 will next be chosen. Next, consideration will be given as to how each source might be chosen or customized to generate frequencies in its assigned sub-band 225. Clearly, each source should be capable of generating the frequencies in its assigned sub-band at some usable amplitude. For sources with a controllable phase, such as marine vibrators, the “source” may in fact consist of an array of sources operating in unison, such that their amplitudes add. Thus, when the term “source” is used herein, that term should be understood to refer to a single physical source or two or more physical sources that are designed to operate in conjunction with each other to generate a composite seismic source signal.

Next, in some embodiments, the sources will be assigned to sub-band source groups 230. In this embodiment, the sources in any given sub-band source group will have largely disjoint frequency ranges, so that they can be separated by bandpass filtering (or, optionally, by another type of frequency filtering). Additionally, in one embodiment a seismic source assigned to a given source sub-band will emit seismic source waves that are largely confined in frequency to the sub-band it is assigned to and, further, seismic sources that are assigned to non-adjacent sub-bands will have minimal or negligible overlap in frequency except possibly, of course, for harmonics and/or noise. In an embodiment, all of the source groups taken together will generate seismic waves that substantially span the total frequency range. In other embodiments, each of the sources will be chosen to have a center frequency within an assigned sub-band and the source will be limited in bandwidth to the assigned sub-band to the extent possible.

The goal that the sources will be separable by frequency suggests that a minimum center frequency and/or frequency bandwidth spacing between sources within a group should be maintained. So, for example, a “sub-woofer” source might be assigned to cover a sub-band of 2-8 Hz, a “woofer” might cover 6-24 Hz, a “mid-range” might cover 18-72 Hz, and a “tweeter” might cover 54-100 Hz. Together these four sub-band sources span the broadband range 2-100 Hz. Note that in some variations the sub-woofer will not overlap with the mid-range, nor will the woofer overlap with the tweeter. Any harmonics and sub-harmonics of each sub-band source should also be taken into account as sources are assigned to groups. In this example the sub-band source bands have been chosen such that the second harmonics within a sub-band source group also will not overlap each other or overlap as few other sub-band frequencies as possible, i.e., the second harmonic of the 2-8 Hz sub-woofer would be 4-16 Hz, which does not overlap the frequency band of the 18-72 Hz midrange. Such seismic survey design considerations are well known to those of ordinary skill in the art.

If the limitations of the available sources make it difficult to choose groups that honor the sub-band frequency and harmonic constraints, step 215 may be revisited to reconsider the choice of sub-bands, or increase the number of groups.

In some sense, each frequency sub-band can be viewed as its own survey with its own spatial sampling requirements, and so will have its own particular preferred inline and crossline shot-spacing requirements. In some variations there will be no need for shots in different frequency sub-bands to use the same acquisition grid (although this might be done in some cases for processing and/or acquisition convenience). In a marine survey, the inline shot spacing may easily be customized simply by choosing a different source repeat interval time. Crossline shot spacing is less conveniently varied, but could be achieved by, for example, alternating lines shot using just the higher-frequency sub-band sources with lines shot using sources covering all the sub-bands. In this way, the higher-frequency sub-band sources would have half the crossline spacing of the others. In a marine case, when working out the sampling requirements for each sub-band, 240, each sub-band source will typically be towed at its own optimal depth. See, for example, Laws, R., and Morice, S. P., 2007, Method of seismic surveying, a marine vibrator arrangement, and a method of calculating the depths of sources: patent U.S. Pat. No. 7,257,049 B1, herein incorporated by reference in its entirety for all purposes.

Consideration should then be made of how to optimally acquire all the sub-bands together at minimal time and expense, and the sub-band surveys modified 240. For example, it is likely that the same cross-line spacing will be used for all sub-bands even if this is not an optimal shot spacing for each frequency sub-band, because if a boat is going to shoot a line it might as well acquire all the frequency bands while doing so. In contrast, the average inline spacing for each sub-band can be customized independently, as this choice has little operational impact on the other sub-band sources. The precise timing of each source may need to be dithered to allow for better separation of the sub-bands in processing.

Consideration should also be given during survey design as to how the sub-band sources in different sub-band source groups will be separated from each other 250: e.g., by time or location, or both. Next, and in one embodiment, continuous recording of the seismic sources via the receivers that have been provided for that purpose will begin (step 255), although for some of the proposed acquisition methodologies the instant invention would work similarly with intermittent recording of each separate shot and/or source group activation.

In some embodiments, next the source(s) and associated groups will be moved into position (step 260) according to the survey plan, after which the sources in a first source group will be activated 265 (e.g., the sources assigned to each group will be simultaneously activated, sequentially activated, or activated separately according to the survey design). Following the activation of the first source group, other source groups may be activated at that same location or moved to another location according to the survey design (step 270). In these embodiments, one or more additional source groups will be activated at the then-current location before moving to the next shot point (step 270). The source activations will be recorded and saved for later processing according to methods well known to those of ordinary skill in the art. In some embodiments, the recording will be continued as the source groups are moved (continuous recording), whereas in other embodiments the recording will stop after the reflections returning from the most recent source group activation have decreased in amplitude to the point where they are no longer useful (intermittent recording).

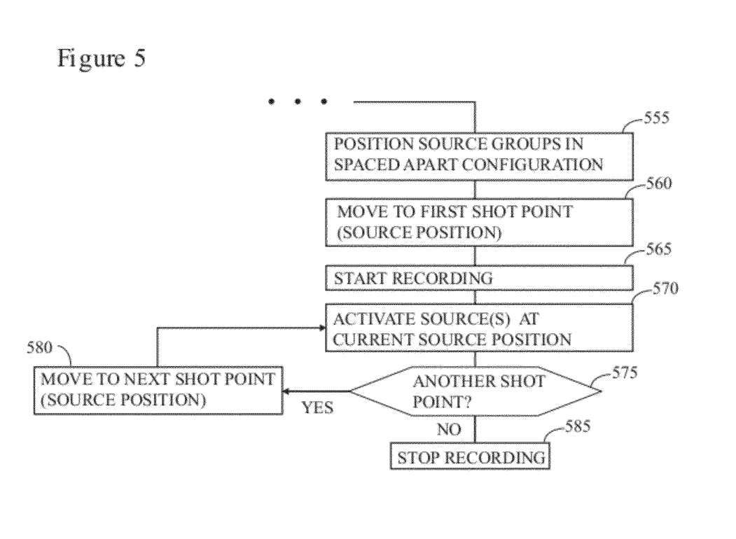

Note that the series of steps that take place inside of bounding box 290 depends on which embodiment of the instant invention is implemented. That is, the embodiment of FIG. 2 most accurately describes the exemplary approaches of plots 320 and 330, i.e., move a source group into position and activate its sources (simultaneously or otherwise) and record (either continuously or intermittently) the data produced from this activation at this location. On the other hand, if the embodiment of plot 340 is implemented, each source group and its sources will be separated at least laterally (and possibly also in time) from the others and, rather than activating each source group at a particular position, instead each source in each group could possibly have its own shooting schedule and shot spacing. For an example of how this might change the steps of FIG. 2, consider FIG. 5.

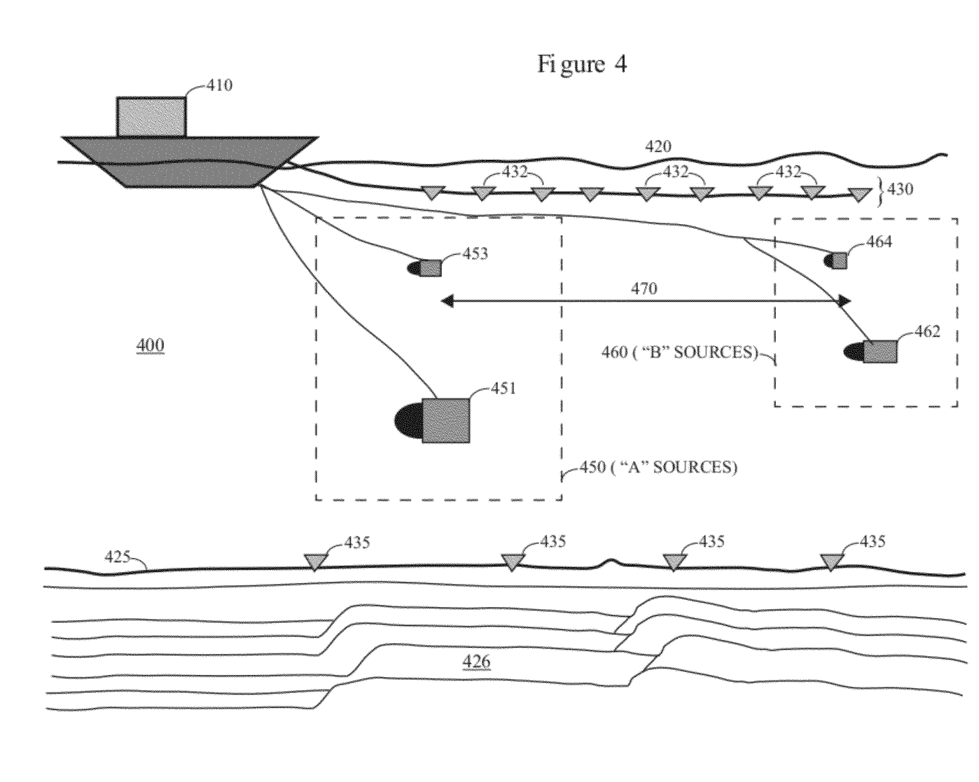

In the example of FIG. 5, the steps 555-585 are intended to replace the steps within the bounding box 290 of FIG. 2. In the arrangement of FIG. 5, it is anticipated that the source groups will be placed into a spaced apart configuration (step 555). That is, and referring to the example of FIG. 4 for purposes of specificity, in this embodiment source groups “A” and “B” will be separated laterally by a distance 470 and such an operation is reflected in step 555. Next, a move to the first shot point will be performed (step 560). Note in this case that the first shot point may not be shared by every source in one of the groups. All that is certain in this example is that there is at least one source in one of the source groups that is to be activated at the moved-to position. Of course, there may be more than one source that is to be activated at that location, including sources from both (or all) source groups.

Next, recording will be initiated using the seismic receivers provided for that purpose. In this arrangement, the recording will most likely be continuous and would end (step 585) only after the survey is completed, after a line is completed, or at some other logical stopping point. That being said, intermittent recording (i.e., where recording is begun before a source activation and terminated some number of seconds thereafter) is certainly a possibility.

Next, the source(s) will be activated at the current position (step 570) and, obviously, reflective and other signals arising from this source activation will be recorded. If there is another shot planned (the “YES” branch of decision item 575), a move will take place to the next shot point location (step 580), after which one or more sources will be activated (step 570). Note that the next shot point location might be associated with a source in the same source group or a source in a different source group, or both. Otherwise, the recording will stop (the “NO” branch of decision item 575 and step 585) and the data transferred, for example, to a central processing facility for further processing and subsequent use in geophysical exploration for hydrocarbon deposits.

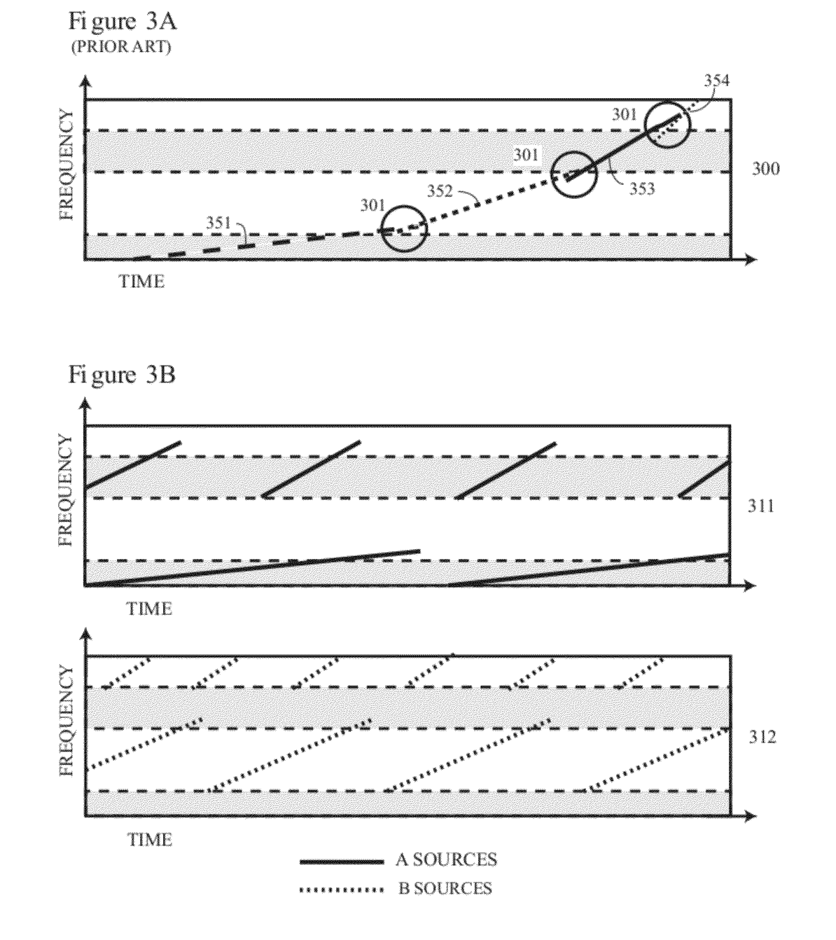

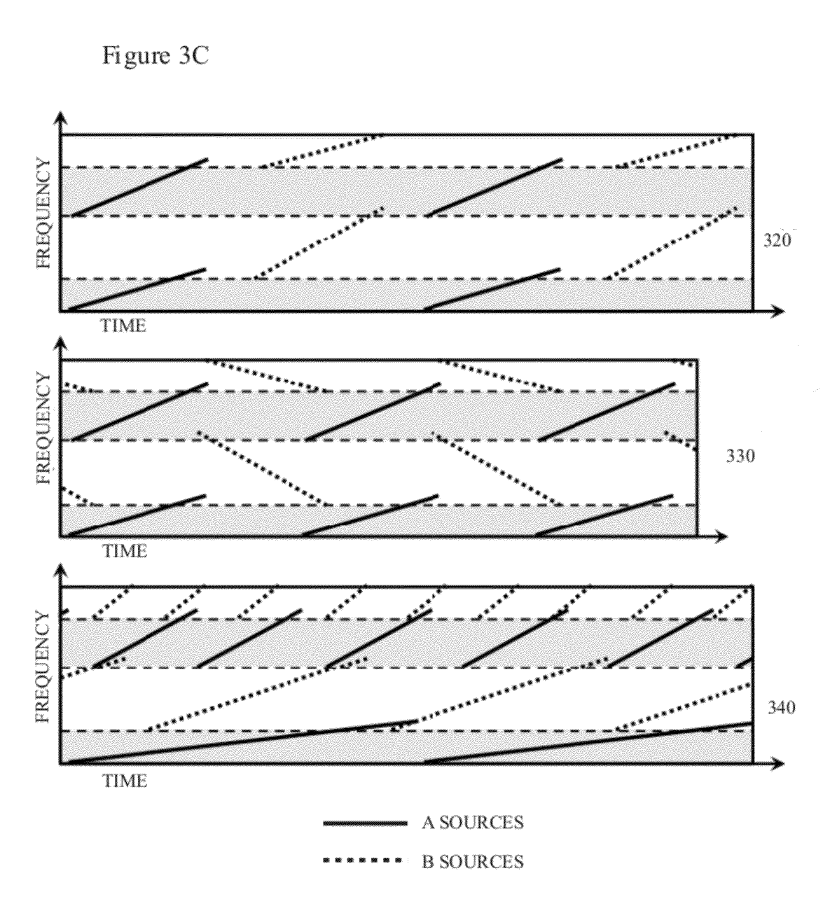

For comparison purposes, FIG. 3A plot 300 has been provided to show an example of an existing survey methodology, wherein four different sources 351, 352, 353, and 354 are utilized. Note that in this example each source 351-354 at least nominally emits seismic energy within a different frequency sub-band as defined by the horizontal dashed lines in this plot 300, which have been shaded to make them easier to differentiate. The conventional approach differs from the disclosed method in several key aspects. First, note there is no notion of grouping the sub-band sources, i.e., there are no “A” or “B” source groups, and hence each sub-band source 351-354 is graphed using a unique line style. As is generally suggested in this figure, in plot 300 the sub-band sources sometimes coincide in time and frequency, as shown by the overlap zones 301 marked in the figure. At the overlap times and frequencies, existing methods rely on being able to separate the sources by careful control of their phase, which may be possible for some types of sources such as vibrators, but not for others. Finally, the conventional approach requires that each sub-band source must allow all the other sources to have their turn before it can fire again, and so spends the majority of its time idle.

Compare the approach of FIG. 3A with the embodiments of the instant invention discussed below in connection with FIGS. 3B-3C. Turning first to FIG. 3B, one approach to separating the sub-band sources would be to simply use just one sub-band source group at a time to shoot the same line (plots 311 and 312). For example, if two sub-band source groups “A” and “B” were utilized, the line could first be shot with the sources of sub-band source-group “A”, and then the same line shot again with sub-band source-group “B”. In this example, the different sub-band source groups could be trivially separated because they would be recorded in separate datasets. The individual sources within each sub-band source group could still be separated by bandpass filtering during processing, taking advantage of the fact that the individual sources have been chosen so that they are trivially separable in frequency. This embodiment is shown schematically in FIG. 3B, plots 311 (“A” sources represented by solid lines) and 312 (“B” sources represented by dashed lines). Note in this case that because the individual sub-band sources within each source group may be operated independently, they do not need to be synchronized as described in the embodiment of steps 260 and 270 in FIG. 2. Instead, each source within a source group could possibly be given its own shot interval which might be independent of the shot intervals of other sources in the same group.

However, the approach of FIG. 3B is not as efficient or cost effective as would be desired because in a marine survey it would require at least two boat passes (e.g., one boat twice or two boats once each) to acquire. However, this technique has the advantage of simplifying the subsequent data processing since the sources within a group will be trivially separable by band pass filtering as has been discussed previously.

Turning next to FIG. 3C, plot 320 contains an example group shooting pattern wherein the “A” group sources and the “B” group sources are activated in alternation, for example, “A, B, A, B”, with the group source activations being separated by sufficient time to, say, allow the reflections from the previous source to decay substantially in amplitude before the next source group is activated. Note that the two techniques discussed above could also be combined: if, for example, there were instead three source groups, “A”, “B”, and “C”, the “A” sources could be operated one day, then “B, C, B, C” the next. The methodology of plot 320 does allow all the sub-band sources to be acquired in one pass, but has the disadvantage that all the sub-band sources within a sub-band group must have the same repeat interval, which may not be optimal, and each sub-band source must spend part of its time idle while the other group(s) are taking their turn to be active.

Note if the sources alternate “A, B, A, B”, and the “A” sources sweep up and the “B” sources sweep down, then it is possible to begin sweeping the “B” sources before the “A” sources have finished sweeping, as shown schematically in FIG. 3C, plot 330. Even though the sources in this example overlap in time, they don't generate the same frequency at the same time, so they can still be separated by making use of time and frequency together. This technique allows for a small but welcome increase in operational efficiency over the 320 example, but otherwise shares most of its advantages and disadvantages.

The embodiments illustrated in FIG. 3C in 320 and 330 are designed to operate the source groups in a synchronized pattern, as described by the procedure in boxes 260 and 270 in FIG. 2. In another embodiment, all of the different sub-band source groups will be allowed to operate simultaneously and independently, as shown in FIG. 3C, plot 340. In this example the “A” (solid line) and “B” (dashed line) sources (i.e., source groups) operate without regard to each other, and the sub-band sources within each group also operate without regard for each other. This is operationally the most efficient, as each sub-band source acquisition can be optimized independently. However, this approach does require more work in the subsequent data processing. Since in this example overlapping sub-band sources cannot be separated by time, and since the source sweeps have not been carefully controlled to make them orthogonal, the overlapping sources will most likely be separated by location, using the fact that the overlapping sources will be in different source groups. In this particular case, the separation would be performed in processing using simultaneous-source-separation techniques known to those skilled in the art. See, for example, Abma (previously referenced).

Note that for simultaneous-source-separation techniques to work best, in most embodiments the sub-band sources at different locations will not be synchronized in their operation. Their unique repeat intervals make them easier to distinguish during subsequent processing and, thus, allow for better separation. In fact, it may be useful to dither the shot initiation times slightly to provide an additional distinguishing characteristic: the pattern of time variations between consecutive corresponding shots. As before, the sources within each sub-band source group, which cannot be separated by location in this example, could be separated by taking advantage of their non-overlapping frequency ranges.

The sub-band sources within any given sub-band source group should, generally speaking, be readily separable by frequency, but sub-band sources that are assigned to different sub-band source groups could potentially substantially overlap in frequency. So, for example, if the lowest-frequency sub-woofer sub-band source were relatively underpowered, a sub-woofer might be included in more than one sub-band source group.

FIG. 4 illustrates an exemplary acquisition methodology that could be used to implement the method illustrated in FIG. 3C, plot 340. A boat 410 will sail right to left on the surface 420 of the ocean 400 over a geological structure 426 of interest that is located beneath the ocean floor 425. The boat 410 tows a seismic recording streamer 430 containing some number of hydrophones/receivers 432. Ocean-bottom 425 receivers 435 may also be used.

In this example the boat also tows two sub-band source groups, sub-band source group “A” 450 and sub-band source group “B” 460. The two sub-band source groups will typically be located sufficiently far apart 470 that conventional simultaneous-source-inversion algorithms can distinguish them by their differing locations. In FIG. 4, Sub-band source group “A” 450 contains a sub-woofer sub-band seismic source 451 and a mid-range sub-band seismic source 453. Sub-band source group “B” 460 contains a woofer sub-band seismic source 462 and a tweeter sub-band seismic source 464. In this example, the four sub-band sources are operated each on their own schedule (as previously shown in FIG. 3C in 340) and towed at their own appropriate depth.

Returning now to FIG. 1, step 120, i.e., conducting the survey, in some embodiments the same receivers will be used to record all the sub-band sources. Since different sub-band sources need not operate on the same schedule, and to avoid edge effects in bandpass filtering, traditional fixed-length traces will generally not be used. In one embodiment it will be generally desirable to record data continuously, in which case the shot locations and times for each sub-band source should be recorded in a separate “source information table”. If the sweeps vary between shots, whether deliberately or because the precise details of the source sweep cannot be controlled, the emitted signal for each source should also be recorded for use by the processing algorithm 130.

Further in connection with the example of FIG. 1, algorithm 130 represents software that implements the pre-processing (post acquisition) steps to render the data recorded by the combined sub-band surveys into a form usable by conventional imaging algorithms 140. Sources within any source sub-band source group configured according to one embodiment can be separated by bandpass filtering, taking advantage of their non-overlapping frequency ranges. Sources in different sub-band source groups can be separated either by time or location, or in some cases both, using simultaneous-source inversion techniques known to those skilled in the art. For this purpose, data recording the emitted signatures of each sub-band source may be used as an additional input to the inversion.

Once the sub-band sources have been separated in processing, the different sub-band surveys may then be correlated (as, e.g., in standard Vibroseis®) to create synthetic band-limited impulsive-source datasets. These may then be interpolated onto a common grid and summed to create a single broadband synthetic impulsive-source dataset suitable for use by conventional imaging algorithms 140. Alternatively, more sophisticated inversion algorithms may be used to combine the sub-band datasets into a single broadband synthetic dataset. Or, the sub-band datasets may be left separated and uncorrelated for use by frequency-domain algorithms such as frequency-domain full-waveform inversion.

According to a first embodiment of the instant invention, there is provided a method of seismic acquisition that utilizes a bank of restricted-bandwidth swept-frequency sub-band sources as a seismic source.

In an embodiment, each sub-band source will be configured to generate a relatively restricted band of frequencies, such that all the sub-band sources taken together cover a predetermined frequency range. In some embodiments the seismic sub-band sources will be selected such that those sources that are generating a signal in frequency bands that are adjacent may partially overlap, but non-adjacent frequency bands will not materially overlap. In one arrangement, the bank of sources will then be divided into two or more groups, such that no sources covering overlapping frequency bands are placed in the same group.

Assuming a configuration similar to the above, the sources within each group can then be easily separated in the frequency domain by simple bandpass filtering. This will allow each source to essentially be operated independently from the others in its group. Each source can then be operated at a depth and on a sweep schedule optimized for its particular frequency band.

Typically the two or more groups will not be separable from each other by bandpass filtering. One solution would be to make a separate acquisition pass for each sub-band source group. Another would be to operate them simultaneously but separated in space, using established methods for separating independent simultaneous sources to separate them, taking advantage of the unsynchronized sweeps being performed by each sub-band source.

It should be clear that sources can readily be separated by simple bandpass filtering if they operate in disjoint frequency bands, regardless of how they may overlap in space or time. So in one embodiment, the desired frequency band can be broken into multiple overlapping sub-bands, and one source (or a synchronized array of sources) assigned to each sub-band. As has been discussed previously, in one embodiment bands should be chosen such that non-adjacent bands are disjoint. The sources can then be divided into two or more groups, such that the source(s) within each group are disjoint in their frequency coverage.

As an example only, the frequency range 1-60 Hz might be broken up into four sub-bands as follows. Group “A” could contain two sources, one covering 1-2 Hz and the other 8-24 Hz, and in group “B” the other two, 2-8 Hz and 24-60 Hz. The survey would then be performed once using the “A” sources, and then again with the “B” sources. As the source(s) for each sub-band are effectively recorded in isolation (after bandpass filtering), each can operate nearly continuously, with the sweep length and interval being determined by the spatial sampling in that frequency band and the limitations of those source(s). The data must similarly be recorded continuously. However, the sources may cover any suitable frequency range and may be divided into any number of groups covering any number of frequency ranges. More particularly, the sources may cover frequencies ranging from about 0 Hz to about 500 Hz, alternatively from about 1 Hz to about 300 Hz, alternatively from about 0.7 Hz to about 100 Hz.

In the context of the previously example, the two or more passes must be separated sufficiently in either space or time such that there is no overlap in the recorded data time window of interest. One way of separating the groups of sources would be to operate them at some distance apart or on different boat passes (i.e. “Group A” one day, Group “B” the next). In another embodiment, the source may be interleaved (i.e., “A”, pause, “B”, pause, “A”, etc.). However, if the latter method is used the pauses between the two groups could be minimized by using up sweeps for “A” and down for “B”.

Recent developments in independent simultaneous sources (e.g., Abma, previously referenced) make it possible to separate multiple sources even if they overlap in time, so long as there is some pseudo-random variation in the pattern of how shots overlap and each source is part of a well sampled sequence that varies continuously from shot to shot. Separation can be greatly assisted if the constituent shots are also separated in space, so they can be further distinguished by their differing locations, which results in a different moveout. So, in another embodiment, the two or more groups of sources will be operated simultaneously, but not at the same location at the same time. The source(s) for each sub-band will be swept on their own schedules, with pseudo-random time separation “dithers” added if needed to improve the separation. Thus, in contrast to previous published methods, the instant embodiment deliberately avoids synchronizing the different sources either in time or, in some embodiments, to the same shot-point grid. After source separation, the recorded data can be correlated, filtered, and interpolated onto a regular grid as needed for conventional processing, or used as-is for methods such as frequency-domain full-waveform inversion.

In locating the sources use can be made of seismic reciprocity. Reciprocity is one reason why a source is not used at each end of a 2D towed-streamer line; by reciprocity, the two source locations would produce redundant data. For example, the “A” sources and the “B” sources of the previous example could be positioned at such reciprocal locations. The data they generate would not be equivalent at least because the sources cover different frequency bands.

In practice there will likely be some unwanted harmonics that cause the “disjoint” sources to slightly overlap in frequency. These effects can be mitigated by varying the timing, sweep parameters and/or sweep direction for the source(s) in each sub-band in a pseudo-random manner according to methods well known to those of ordinary skill in the art. Additionally, it might be desirable in some instances to modify the start time, start and end sweep frequencies, sweep rate, sweep profile, and sweep direction in a non-random (deterministic) manner in order to avoid unfavorable sweep combinations that might otherwise occasionally occur by chance if these parameters were chosen in a truly random manner. The source signatures should be recorded and any variation (either deliberate or accidental) used to improve the separation. Signature variety will also help any remaining unwanted crosstalk interference to stack out. Each source should be towed at its optimal depth to take full advantage of the surface ghost anti-notch as has been noted elsewhere.

Generally, the sub-band sources may operate in a non-synchronized fashion. This freedom makes it possible to optimize each sub-band source relatively independently. They do not need to operate on the same shot grid (which allows shot spacing to be optimized to the frequency band of each sub-band source). They do not need to have sweeps of the same length (which allows for greater freedom of source design). Sources do not have to wait for all the others to finish before they can go again (allowing each source to spend as much time radiating as it can, without regard for the requirements of the others, so achieving increased operating efficiency). Instead of avoiding crosstalk between the sub-band sources by careful control of the phase of the sources, or requiring synchronized sweeping of all the sources, the sources of the instant invention may be separated into sub-band source groups by shot time, by varying shot characteristics in a pseudo-random manner, and/or by shot location.

In the foregoing, much of the discussion has been in terms of marine seismic surveys, but that was done for purposes of illustration only and not out of an intent to limit the application of the instant invention to only marine seismic surveys. Those of ordinary skill in the art will understand how the embodiments presented supra could readily be applied to land surveys, marine surveys, or any combination of same.

The seismic source might be one that is customizable with respect to the range of frequencies that it generates. On land, standard seismic vibrators would be suitable, as the sweep that is employed can be varied according to methods well known to those of ordinary skill in the art to produce a source signal with characteristics that are at least approximately band limited as has been discussed above. In the marine case, swept-frequency marine sources (marine vibrators, resonators, water sirens, etc.) can be tuned or adjusted to provide a substantially band-limited signal suitable for use with the instant invention. Of course, those of ordinary skill in the art will be able to devise other methods of selecting sources that can be tuned or other adjusted to yield a seismic signal that is confined to a particular frequency range.

Additionally it should be noted that the frequency bandwidths given herein (e.g., 1-300 Hz) have been provided for purposes of specificity only and not out of any intent to limit the application of the disclosed methods to only those bandwidths. The target bandwidth for a given survey will typically be selected after consideration of a number of factors (e.g., cost constraints, survey location, type of source, type and objective of the survey, etc.).

Further, although the frequency sub-bands discussed herein have generally been described as being non-overlapping, those of ordinary skill in the art will understand that in practice after the sub-bands are populated with seismic sources, it is almost inevitable that the seismic signals produced by activating the source(s) within each sub-band will overlap at least minimally in frequency (e.g., the upper harmonics of one source will likely overlap the source frequencies in one or more other higher-frequency sub-bands). Thus, when it is said that sub-bands are to be selected to cover a frequency range herein, it should be understood that after one or more seismic sources are associated with each sub-band, the resulting seismic signals will almost certainly radiate at frequencies outside of the assigned sub-band range, although it would generally be desired to limit the seismic energy outside the sub-band as much as possible. Additionally, when it is said that the seismic sources are to be selected in such a way as to “cover” or “be within” a frequency sub-band, that terminology should be understood by reference to the sorts of general frequency content constraints that are typical of customizable and other seismic sources, e.g., it is usually impractical or impossible to create seismic sources that have hard frequency band limits. Thus, interpretation of these sorts of terms should reflect the practicalities of modern seismic sources.

In the previous discussion, the language has been expressed in terms of operations performed on conventional seismic data. But, it is understood by those skilled in the art that the invention herein described could be applied advantageously in other subject matter areas, and used to locate other subsurface minerals besides hydrocarbons. By way of example only, the same approach described herein could potentially be used to process and/or analyze multi-component seismic data, shear wave data, converted mode data, cross well survey data, VSP data, full waveform sonic logs, controlled source or other electromagnetic data (CSEM, t-CSEM, etc.), or model-based digital simulations of any of the foregoing. Additionally, the processing methods claimed hereinafter can be applied to mathematically transformed versions of these same data traces including, for example: filtered data traces, migrated data traces, frequency-domain Fourier-transformed data traces, transformations by discrete orthonormal transforms, instantaneous phase data traces, instantaneous frequency data traces, quadrature traces, analytic traces, etc. In short, the process disclosed herein can potentially be applied to a wide variety of types of geophysical time series, but it will most often be applied to a collection of spatially related time series.

While the inventive device has been described and illustrated herein by reference to certain embodiments in relation to the drawings attached hereto, various changes and further modifications, apart from those shown or suggested herein, may be made therein by those skilled in the art, without departing from the spirit of the inventive concept, the scope of which is to be determined by the following claims.

What is claimed is:

1. A method of seismic exploration above a region of the subsurface of the earth containing structural or stratigraphic features conducive to the presence, migration, or accumulation of hydrocarbons, comprising:
(a) positioning at least two seismic source groups over said region of the earth, wherein each seismic group comprises a plurality of seismic sources, wherein at least one of said seismic source groups is assigned at least two frequency sub-bands, wherein said frequency sub-band(s) assigned to a single seismic source group do not overlap in frequency, and wherein all of said frequency sub-bands taken together substantially cover a predetermined frequency range;
(b) assigning at least one of said seismic sources to each of said frequency sub-bands, wherein each seismic source assigned to one of said frequency sub-bands emits seismic sources waves that are confined in frequency to its assigned sub-band;
(c) assigning each of said at least two frequency sub-bands and said at least one seismic source assigned thereto to one of at least two seismic source groups in such a way that no two adjacent frequency sub-bands are assigned to any one of said seismic source groups; and
(d) collecting a seismic survey above said region of the subsurface of the earth by activating each of said source groups proximate to said region of the subsurface of the earth and recording any seismic signals returned from the subsurface of the earth; and,
(e) displaying at least a portion of said seismic survey on a computer associated display device.

2. The method according to claim 1, wherein step (d) comprises:
(d1) collecting a seismic survey above said region of the subsurface of the earth by alternately activating each of said at least two said source groups proximate to said region of the subsurface of the earth and continuously recording any seismic signals returned from the subsurface of the earth.

3. The method according to claim 1, wherein step (d) comprises:
(d1) collecting a seismic survey above said region of the subsurface of the earth by sequentially activating each of said at least two source groups proximate to said region of the subsurface of the earth, wherein said seismic sources assigned to each source group are activated simultaneously, and,
recording any seismic signals returned from the subsurface of the earth.

4. The method of claim 1 wherein all of said seismic sources assigned to any of said sub-bands are marine seismic sources.

5. The method of claim 4 wherein all of said seismic sources assigned to said at least one of said plurality of source groups are towed at depths individually optimized for a frequency band of each source.

6. The method of claim 1 wherein said frequency range is about 1 Hz to about 100 Hz.

7. The method of claim 1, wherein step (d) comprises:
(d1) collecting a seismic survey above said region of the subsurface of the earth by activating in turn each of said source groups proximate to said region of the subsurface of the earth, wherein each of said alternately activated source groups is separated in time from a next source group activation by a random period of time, and,
recording any seismic signals returned from the subsurface of the earth.

8. The method of claim 1 wherein at least one of said seismic sources assigned to said at least one of said plurality of source groups is selected from a group consisting of a land vibrators, a marine vibrator, a resonator, and a water siren.

9. The method of claim 1 wherein all of said seismic sources assigned to any of said sub-bands are customizable seismic sources.

10. A method of seismic exploration above a region of the subsurface of the earth containing structural or stratigraphic features conducive to the presence, migration, or accumulation of hydrocarbons, comprising:
(a) selecting at least two frequency sub-bands, wherein said at least two sub-bands substantially covers a predetermined frequency range, and wherein non-adjacent sub-bands do not overlap in frequency;
(b) assigning at least one seismic source to each of said sub-bands, wherein a seismic source assigned to a particular sub-band emits seismic source waves that are confined in frequency to its assigned particular sub-band;
(c) assigning each of said at least two sub-bands and said at least one seismic source assigned thereto to one of at least two source groups in such a way that no two adjacent sub-bands are assigned to a same source group;
(d) collecting a seismic survey above said region of the subsurface of the earth by activating each of said seismic sources proximate to said region of the subsurface of the earth and recording any seismic signals returned from the subsurface of the earth; and,
(e) using at least a portion of said seismic survey to explore for hydrocarbons within said subsurface of the earth.

11. The method according to claim 10, wherein step (d) comprises the step of:
(d1) collecting a seismic survey above said region of the subsurface of the earth by activating each of said seismic sources proximate to said region of the subsurface of the earth and continuously recording any seismic signals returned from the subsurface of the earth.

12. The method of claim 10 wherein all of said seismic sources assigned to any of said sub-bands are marine seismic sources.

13. The method of claim 12 wherein all of said seismic sources assigned to said at least one of said plurality of source groups are towed at depths individually optimized for a frequency band of each source.

14. The method of claim 10 wherein said frequency range is about 1 Hz to about 100 Hz.

15. The method of claim 10, wherein step (d) comprises the steps of:
(d1) collecting a seismic survey above said region of the subsurface of the earth by activating each of said seismic sources proximate to said region of the subsurface of the earth and continuously recording any seismic signals returned from the subsurface of the earth, wherein a first seismic source activation is separated by a random period of time from a subsequent seismic source activation, and,
recording any seismic signals returned from the subsurface of the earth.

16. The method of claim 10 wherein at least one of said seismic sources assigned to said at least one of said plurality of source groups is selected from a group consisting of a land vibrators, a marine vibrator, a resonator, and a water siren.

17. The method of claim 10 wherein all of said seismic sources assigned to any of said sub-bands are customizable seismic sources.

18. A method of seismic exploration, wherein is provided a frequency range and a plurality of frequency sub-bands that at least approximately span said frequency range, comprising, wherein sub-bands that are not adjacent in frequency are disjoint, comprising the steps of:
(a) associating at least one customizable seismic source with each of said plurality of sub-bands, wherein each of said seismic sources associated with a particular sub-band is customized to emit a seismic signal substantially within said particular sub-band;
(b) assigning each of said sub-bands and any seismic sources associated therewith to one of at least two source groups such that no two adjacent sub-bands are assigned to a same source group;
(c) activating the sources assigned to a particular source group;
(d) recording a plurality of reflected seismic signals representative of one or more subterranean formations;
(e) performing steps (c) and (d) for each of said source groups, wherein each source group activation of step (c) is separated from a preceding source group activation by either a period of time or by a lateral distance, thereby obtaining a seismic survey that images at least a portion of said one or more subterranean formations; and,
(f) using at least a portion of said seismic survey to explore for hydrocarbons within the subsurface of the earth.

19. A method of seismic exploration above a region of the subsurface of the earth containing structural or stratigraphic features conducive to the presence, migration, or accumulation of hydrocarbons, comprising:
(a) selecting a frequency range;
(b) selecting a plurality of sub-bands of said frequency range, said plurality of frequency sub-bands taken together substantially covering said selected frequency range;
(c) associating at least one seismic source with each of said plurality of frequency sub-bands, wherein each seismic source associated with one of said plurality of frequency sub-bands at least approximately covers said associated frequency sub-band;
(d) assigning each of said plurality of sub-bands and said at least one seismic source associated therewith to one of at least two source groups in such a way that no two adjacent sub-bands are assigned to a same source group;
(e) collecting a seismic survey by separately recording activations of said seismic sources associated with each of said each of said at least two source groups, wherein activation of said seismic sources associated with one source group does not materially overlap in time activation of said seismic sources associated with another source group; and,
(f) using at least a portion of said seismic survey to explore for hydrocarbons within said subsurface of the earth.

20. A method of seismic exploration within the subsurface of the earth, comprising the steps of:
(a) accessing a seismic data set collected by the steps of:
(1) selecting a plurality of sub-bands that substantially cover a frequency range;
(2) associating at least one seismic source with each of said plurality of frequency sub-bands, wherein each seismic source associated with one of said plurality of frequency sub-bands emits seismic energy that is largely confined to said associated frequency sub-band;
(3) assigning each of said plurality of sub-bands and said at least one seismic source associated therewith to one of at least two source groups in such a way that no two adjacent sub-bands are assigned to a same source group; and,
(4) collecting said seismic data set by recording activations of said seismic sources associated with each of said each of said at least two source groups, wherein activation of said seismic sources associated with one source group is separated either in time or in distance from activation of said seismic sources associated with a different source \group; and,
(b) using at least a portion of said accessed seismic data set to explore for hydrocarbons within the subsurface of the earth.
